(19) United States
(12) Patent Application Publication
(10) Pub. No.: US 2003/0070893 A1
(43) Pub. Date: Apr. 17, 2003

(54) Hydraulic dashpot

(76) Inventors: Adolf Adrian, Ennepetal (DE); Andreas Nevoigt, Hagen (DE)

Correspondence Address: Dr. Max Fogiel, 61 Ethel Road West, Piscataway, NJ, 08854, US

(21) Appl. No.: 10/246,643

(22) Filed: Sep. 18, 2002

(30) Foreign Application Priority Data
Oct. 16, 2001 (DE) 101 51 023.3

(51) Int. Cl. F16F 9/36

(52) U.S. Cl. 188/322.16

(57) ABSTRACT

A hydraulic dashpot with a piston rod that travels back and forth into and out of a cylinder (4), which it is sealed off from and aligned with by a sheet-metal subassembly. The sealing-and alignment assembly consists of a support with a collar that can accommodate a piston-rod centering sleeve (5) and of a seal (6) reinforced by a sheet-metal disc and whereby the support and/or the disc (7) are in one or more components. To further simplify the sealing-and-alignment assembly and to simplify the assembly's structure not only as such but in conjunction with the dashpot, at least one component of the support (1) is form fit or substance fit to at least one component of the sheet-metal disc 7.

The present invention concerns a hydraulic dashpot with a piston rod that travels back and forth into and out of a cylinder, which it is sealed off from and aligned with by a sheet-metal subassembly as recited in the preamble to claim 1.

Dashpots of this genus, which are mainly employed as shock absorbers between the wheels and the bodies of vehicles, are known from German 4 030 788 A1. The sealing-and-alignment assembly described therein is already a very simple structure comprising various pieces of sheet metal and a sheet-metal reinforced seal.

There is a drawback to such a sealing-and-alignment assembly in that it is complicated to assemble. Many individual components must be introduced separately over the piston rod and subsequently into the cylinder. These individual components cannot be fastened together until the overall dashpot is finally assembled, when, as disclosed in German 4 030 788, that is, the end of the cylinder is folded in over the sealing-and-alignment assembly.

The object of the present invention is not only to further simplify the sealing-and-alignment assembly but to simplify the assembly's structure not only as such but in conjunction with the dashpot.

This object is achieved by the characteristics recited in the body of claim 1. Further and advanced embodiments are addressed in claims 2 through 6.

The advantage of the present invention is that the components of the sealing-and-alignment assembly are not introduced separately but are preliminarily assembled, which substantially simplifies final assembly.

One embodiment of the present invention will now be specified with reference to the accompanying drawing.

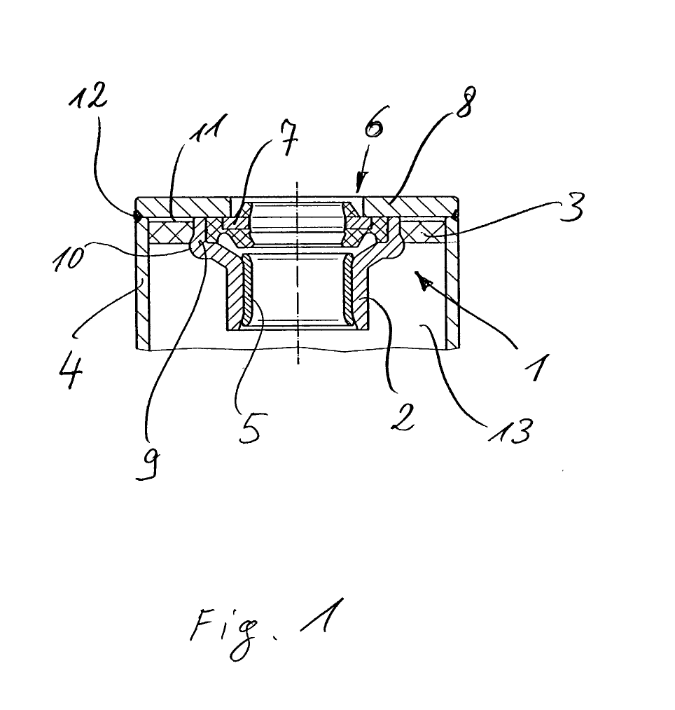

FIGS. 1 through 3 are cross-sections through the end of a dashpot cylinder, specifically the end that the unillustrated piston rod exits through. This end is capped by a sealing-and alignment assembly that allows the rod to exit through it only sealed. The rod, however, can still travel back and forth into and out of the cylinder.

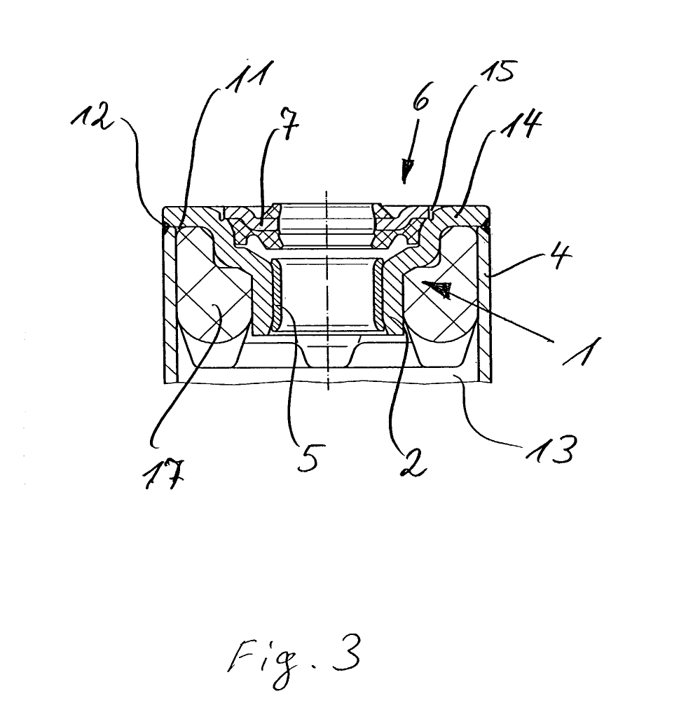

FIGS. 1 and 3 are sections through different embodiments of sealing-and-alignment assemblies and of means of fastening them to the piston-rod exit end of the cylinder.

The support 1 illustrated in FIG. 1 is composed of two parts—a bushing 2 surrounded at its upper end by an annular flange 3. Annular flange 3 rests radially inward against a dashpot cylinder 4. A sleeve 5 of low-friction material rests against the inner surface of bushing 2. Sleeve 5 centers and aligns an unillustrated piston rod.

A seal 6 is accommodated above piston-rod centering sleeve 5, beyond it, that is, as viewed from cylinder 4. The seal 6 employed in every one of the embodiments described herein has two or more lips and is reinforced axially and radially by a sheet-metal disc 7 embedded therein by molding or vulcanization. To prevent the piston rod from rubbing against it, the inside diameter of sheet metal disc 7 is slightly longer than that of piston-rod centering sleeve 5.

The upper outer surface of sheet-metal disc 7 is not surrounded by elastic sealing material and accordingly constitutes a contact surface. The disc can be of hard plastic or metal.

At least some sections of a bearing surface 8 rest on the segment of sheet-metal disc 7 not enclosed in sealing material. Seal 6 is forced into a collar 9 around bushing 2. To finally assemble annular flange 3, bushing 2 is cemented or preferably welded from outside to bearing surface 8. If the joint is welded from outside, welding residue at the root of the seam will be prevented from penetrating into the dashpot's working chamber 13 because seal 6 occupies the adjacent space, inside collar 9, that is, and seals the root off from the inside of the dashpot. Once bushing 2 and bearing surface 8 have been welded, the sealing-and-alignment assembly will be entirely together and can constitute a single component in assembling the final dashpot. The annular flange 3 around support 1, which is neither cemented nor welded to bushing 2, cannot come loose from the bushing, which is surrounded at the bottom by a bead 10 that annular flange 3 cannot slide down over.

Once the dashpot has been finally assembled, the sealing-and alignment assembly is introduced into the end of cylinder 4 and seated onto it. The finally assembled dashpot is then closed by welding bearing surface 8 to cylinder 4 from outside, leaving an essentially sealed annular gap 11 in the vicinity of the root of seam 12 between surface 8 and cylinder 4. Any welding residue detaching from the root will accordingly be isolated in gap 11 and will be prevented from penetrating into working chamber 13 or into the vicinity of the seal 6 or of piston-rod centering sleeve 5.

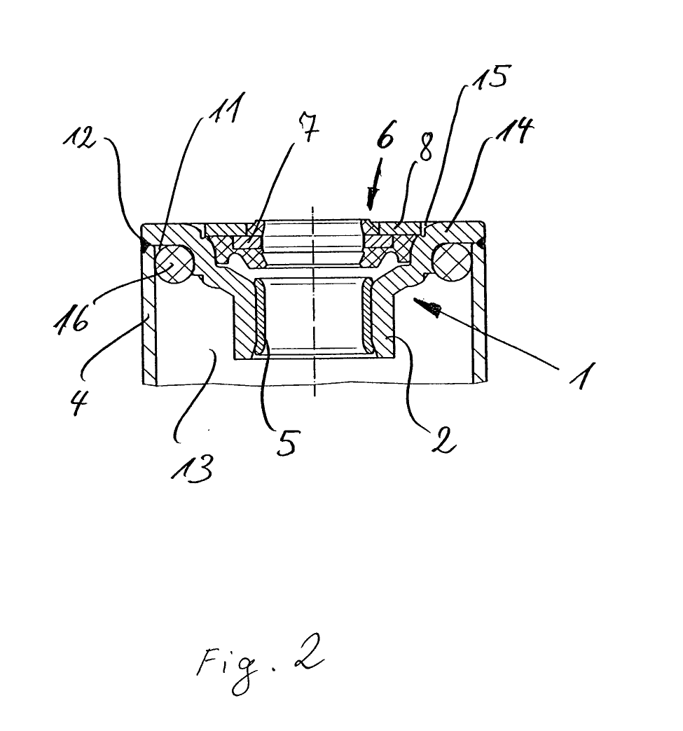

The sealing-and-alignment assembly illustrated in FIG. 2 is similar to the one illustrated in FIG. 1. Bushing 2 continues directly by way of a collar 14 as far as the outer circumference of cylinder 4. The sheet-metal disc 7 in this embodiment as well is not completely embedded in sealing material. As in the embodiment depicted in FIG. 1, the whole area is left free. A bearing surface 8 can again rest against this area. The bearing surface 8 in this embodiment, however, will have a slightly shorter diameter than the one in the embodiment depicted in FIG. 1. It is accommodated in a recess 15 in support 1 intended to accommodate a welding seam. Bearing surface 8 and support 1 are welded together from outside in this area. Since the root of this seam is closed by the forced-in seal 6, any welding residue detaching at the root will be prevented from penetrating into working chamber 13 or into the vicinity of the seal 6 around piston-rod centering sleeve 5. Bearing surface 8 and support 1 can be cemented or caulked together instead of welded.

Once the present embodiment of the dashpot has been totally assembled, support 1 will be welded, from outside in this event as well, to cylinder 4. The root of seam 12 will here again be sealed off from working chamber 13 and hence from seal 6 or piston-rod centering sleeve 5. The annular gap 11 that isolates the welding residue is created in the present embodiment by the insertion of an O ring 16.

The embodiment of a sealing-and-alignment assembly depicted in FIG. 3 represents an alternative to the one depicted in FIG. 2. Since sheet-metal disc 7 is one-piece, it can also replace the bearing surface 8 depicted in FIG. 2.

The gap 11 in this embodiment is constituted not by an O ring 16 as in the one illustrated in FIG. 2 but by a tension limiter 17 of elastic material. The sealing-and-alignment assembly illustrated in FIG. 3 corresponds in form and function to the one illustrated in FIG. 2.

All the welding hereintofore specified can be either point welding or seam welding. The seams need not be tight because the individual components are sealed off from the atmosphere by interior seals or sealing components.

### LIST OF PARTS

1. support

2. bushing

3. annular flange

4. cylinder

5. piston-rod centering sleeve

6. seal

7. sheet-metal disc

8. bearing surface

9. collar

10. bead

11. gap

12. seam

13. working chamber

14. collar

15. recess

16. O ring

17. tension limiter

1. Hydraulic dashpot with a piston rod that travels back and forth into and out of a cylinder (4) that it is sealed off from and aligned with by a sheet-metal subassembly, whereby the sealing and-alignment assembly consists of a support with a collar that can accommodate a piston-rod centering sleeve (5) and of a seal (6) reinforced by a sheet-metal disc and whereby the support and/or the disc (7) are in one or more components, characterized in that at least one component of the support (1) is form fit or substance fit to at least one component of the sheet-metal disc 7.

2. Dashpot as in claim 1, characterized in that the support (1) and the sheet-metal disc (7) are fastened together by welding, cementing, caulking, and/or riveting.

3. Dashpot as in claim 1 or 2, characterized in that the sheet metal disc (7) that reinforces the seal (6) is a stack of two sheet-metal rings.

4. Dashpot as in claim 3, characterized in that the outer ring (bearing surface 8) extends up to and is fastened to the cylinder (4).

5. Dashpot as in one or more of claims 1 through 4, characterized in that, if the support (1) and the sheet-metal disc (7) are welded together, the welding is done from outside and the root of the seam is sealed off from the interior of the dashpot by an inserted component, preferably by part of the seal (6).

6. Dashpot as in one or more of claims 1 through 5, characterized in that the sealing-and-alignment assembly is welded from outside to the cylinder (4) and the root of the seam is sealed off from the interior of the dashpot by an inserted component, preferably a sheet-metal component, an O ring, or a tension limiter (17).
